(19) United States
(12) Patent Application Publication
(10) Pub. No.: US 2004/0129855 A1
(43) Pub. Date: Jul. 8, 2004

(54) Hammering inserting rod

(76) Inventor: Shiow-Hui Chen, Hsin Chu (TW)

Correspondence Address: Shiow-Hui Chen, 235 Chung-Ho Box 8-24, Taipei, TW

(21) Appl. No.: 10/336,160

(22) Filed: Jan. 6, 2003

(51) Int. Cl. F16M 13/00

(52) U.S. Cl. 248/545

(57) ABSTRACT

A hammering inserting rod comprises a tube body; an inserting head secured to a bottom of the tube body; a bottom of the inserting rod being a tip end; a stopper secured to a top of the tube body; and a center of the stopper having a through hole; a linkage passing through the through hole of the stopper; a lower end of the linkage being installed with an inner hammer; a hammer portion secured to a top end of the linkage. By above components, a user holds the hammer portion to lift and descend the hammer portion repeatedly; the hammer portion will beat the stopper; or the inner hammer is used to beat the stopper so that the tube body and inserting head are inserted into soil or separates from ground.

### FIELD OF THE INVENTION

The present invention relates to inserting rods, and particularly to an inserting rods for installing other objects, such as an umbrella, a flag, an indicating rod, a Y shape supporter, a camping support rod, or a rope. A hammer portion is located above an inserting rod, by lifting and descending the hammer portion repeatedly; the hammer portion will beat the stopper; or the inner hammer is used to beat the stopper so that the tube body and inserting head are inserted into soil or separates from ground.

### BACKGROUND OF THE INVENTION

In general, a hammer is used to beat a top end of an umbrella, a flag rod, an indicating rod, a Y shape rod, a camping supporter, etc. so as to make these tools to enter into soil. However, this is inconvenient. Moreover, some accidents occur due to use of the hammer. To improve this defect, in U.S. Pat. No. 6,267,127, “SELF-ANCHORING BEACH UMBRELLA”, an inserting rod is installed with a ring and an inner ring is installed at an inner side of the umbrella shaft. The user holds the umbrella by two hands; and then the umbrella shaft beats the inserting rod. Then the inserting rod will insert into soil for being fixed therein. However, above mentioned prior art has the following defect. After the inserting rod is inserted, it is difficult to pull it out. The user -may hold the beach used umbrella. The umbrella is too heavy to be used by children or younger. The upper open end will receive dusts, soils or stones so that it is necessary to clean the inserting rod. Moreover, the collision operation will damage the inserting rod and umbrella.

### SUMMARY OF THE INVENTION

Accordingly, the primary object of the present invention is to provide a hammering inserting rod which comprises a tube body; an inserting head secured to a bottom of the tube body; a bottom of the inserting rod being a tip end; a stopper secured to a top of the tube body; and a center of the stopper having a through hole; a linkage passing through the through hole of the stopper; a lower end of the linkage being installed with an inner hammer; a hammer portion secured to a top end of the linkage. By above components, a user holds the hammer portion to lift and descend the hammer portion repeatedly; the hammer portion will beat the stopper; or the inner hammer is used to beat the stopper so that the tube body and inserting head are inserted into soil or separate from ground.

The various objects and advantages of the present invention will be more readily understood from the following detailed description when read in conjunction with the appended drawing.

### BRIEF DESCRIPTION OF THE DRAWINGS

FIG. 1 is an exploded perspective view of inserting rod in the first embodiment of the present invention.

FIG. 2 is an assembled perspective view of inserting rod in the first embodiment of the present invention.

FIG. 3 is a cross sectional view of the inserting rod in the first embodiment in of the present invention.

FIGS. 4 to 6 are a schematic view showing the operation of the inserting rod in the first embodiment of the present invention.

FIGS. 7 to 11 are schematic view showing the embodiment of the present invention.

FIG. 12 is a whole cross sectional view about the second embodiment of the present invention.

FIG. 13 is a whole cross sectional view about the third embodiment of the present invention.

FIG. 14 is a schematic view showing the operation of the third embodiment of the present invention.

### DETAILED DESCRIPTION OF THE PREFERRED EMBODIMENTS

First Embodiment

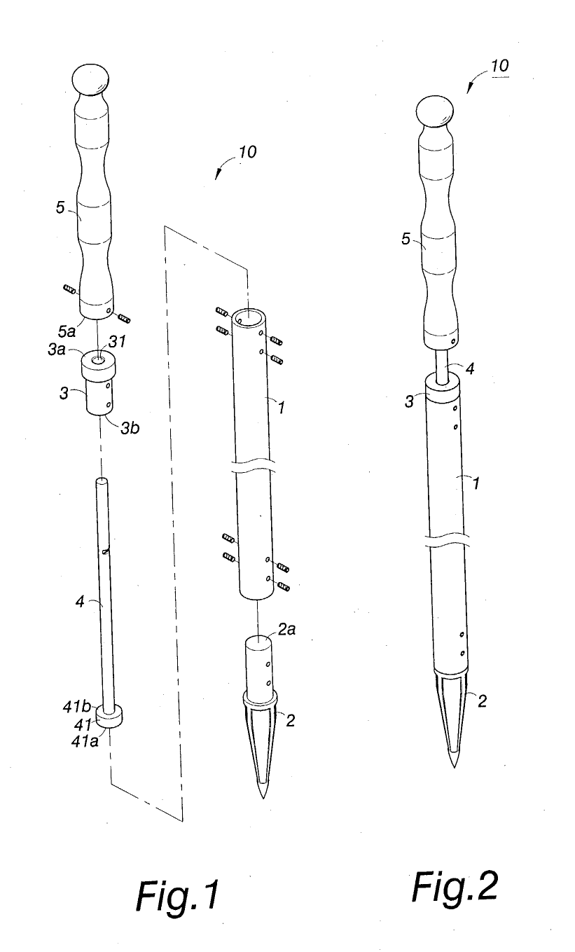

Referring to FIG. 1, the hammering inserting rod of the present invention is illustrated. The hammering inserting rod includes a tube body 1, an inserting head 2 below the tube body 1, a stopper 3 sealing a top of the tube body 1, a linkage 4 capable of being inserted into the stopper 3 and then entering into the tube body 1, and a hammer portion 5 connected to the linkage 4. An assembled perspective view of the hammering inserting rod of the present invention is illustrated in FIG. 2.

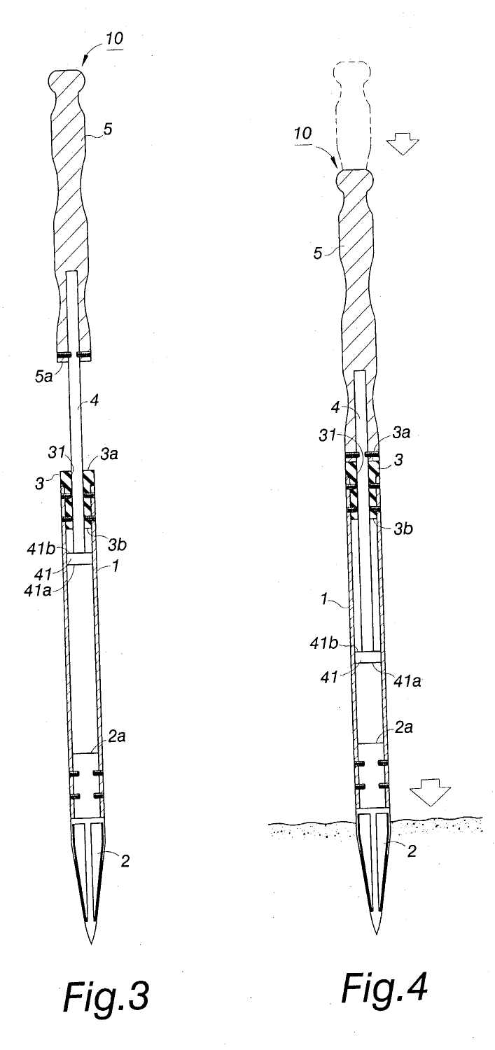

Referring to FIGS. 1 and 3, a whole cross sectional view of the inserting rod according to the present invention is illustrated in FIG. 3. The tube body 1 is a hollow body. The length of the tube body 1 can be determined as desired. The inserting head 2 is installed at a bottom of the tube body 1. The inserting head 2 can be made individually or integrally with the tube body 1. A lower end of the inserting head 2 is a tip end for being inserted into soil. A center of the stopper 3 has a through hole 31 for being passed by the linkage 4. The stopper 3 seals and combines an upper end of the tube body 1 by screws or studs. Besides, the stopper 3 can be integrally formed with the tube body 1 so as to have the same effect and function. Namely, if a diameter of an upper side of the tube body 1 is reduced by forging or punching, it has the same effect as the stopper 3. The linkage 4 is a long rod which can be inserted into the through hole 31. A lower end of the linkage 4 has an inner hammer 41 and a top of the linkage 4 has a connecting hammer portion 5. The hammer portion 5 is an outer hammer. The shape of the hammer portion can be prolonged for being held easily and a surface of the hammer portion may be formed with textures for preventing from sliding.

The operation of the present invention will be described herein with reference to FIG. 4. In use, the user lifts the hammer portion 5 to a predetermined height (referring to FIG. 3). Then a force is applied to the hammer portion 5 to descend. Then a bottom 5a thereof beats a top surface 3a of the stopper 3. Thereby, the hammer portion 5 lifts and descends repeatedly to beat the stopper 3 continuously. Then the inserting head 2 will enter into the soil gradually so that the tube body 1 can be firmly secured in the soil easily. Besides, if the tube body 1 is short, by the bottom surface 41a of the inner hammer 41 in the tube body 1 to beat a top surface 2a of the inserting head 2, the tube body 1 and the inserting head 2 will enter into soil. In above two embodiments, the former one is preferred. Because when the tube body 1 is applied with a force, the inserting head 2 is also affected. If only the inserting head 2 suffers a force, the tube body 1 is only affected slightly. Thereby, the descending speed is low.

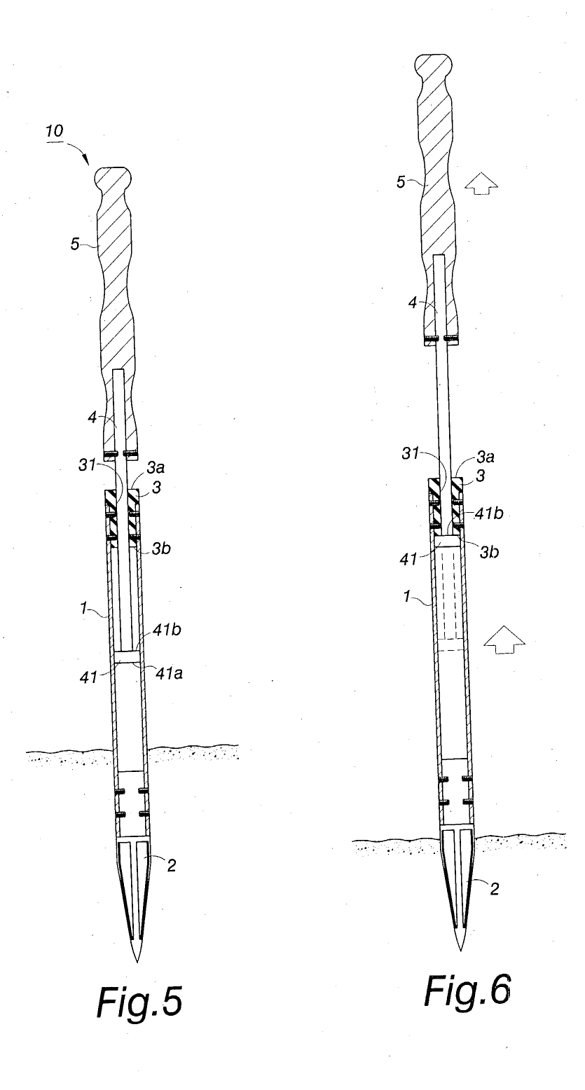

With reference to FIG. 5, if it is desired to separate the inserting rod 10 from the ground, the hammer portion 5 is descended to a lowest point, then the hammer portion 5 is lifted rapidly so that the top surface 41b of the inner hammer 41 in the tube body 1 beats a bottom surface 3b of the stopper 3, as shown in FIG. 6. The inner hammer 41 beats the stopper 3 repeatedly, the tube body 1 and inserting head 2 moves upwards and then separate from the ground. Thereby, the inserting rod 10 will leave the ground easily.

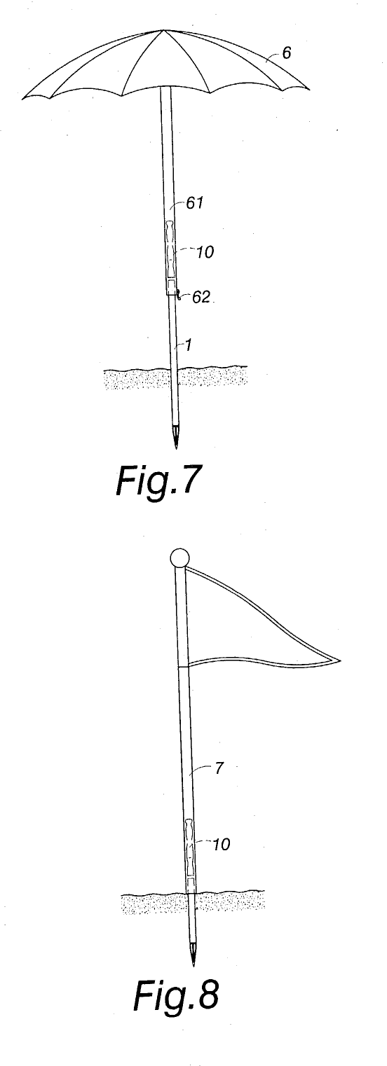

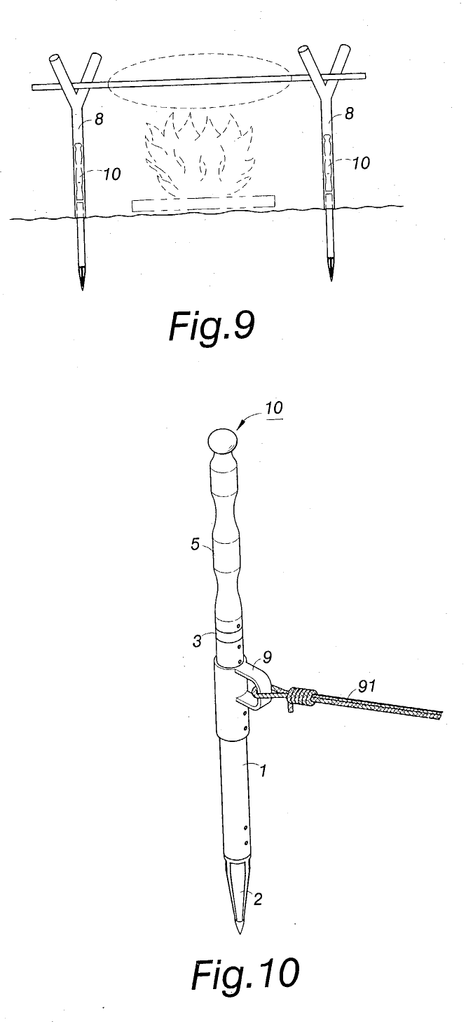

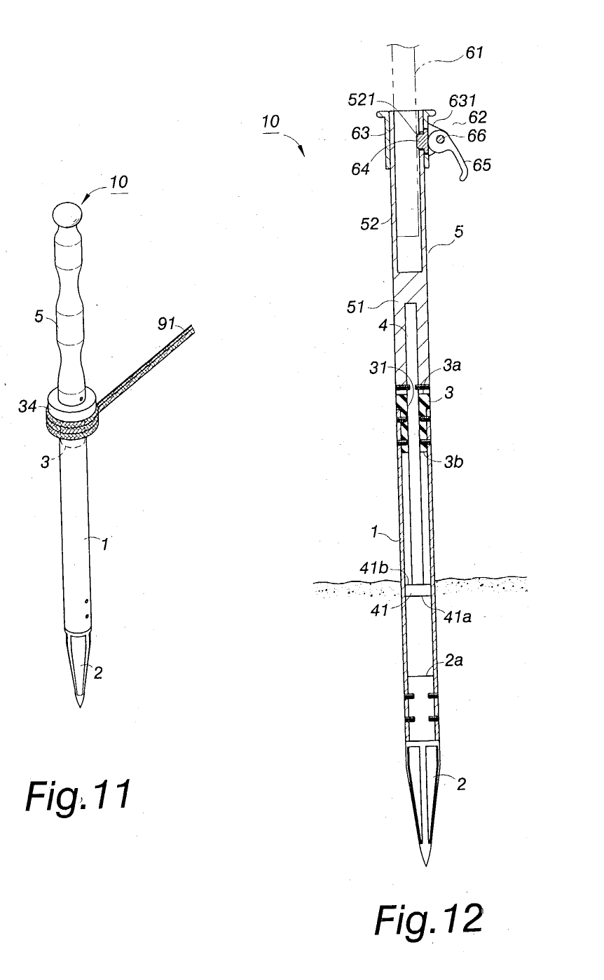

The present invention can be used in various products. Referring to FIG. 7, an umbrella tube 61 of a sun-shielding umbrella 6 can be used with the present invention. That is, the inserting rod 10 is inserted into soil firstly. Then the umbrella tube 61 is buckled to the inserting rod 10 by a buckle 62. Moreover, referring to FIG. 8, a hollow flag 7 is inserted into the inserting rod 10. Referring to FIG. 9, a Y shape frame 8 inserted into the inserting rod 10. As shown in FIG. 10, an ear 9 (or a through hole) is installed at an outer surface of the tube body 1 of the inserting rod 10 for tying a rope 91 for being used in camping. A top of the tube body 1 may be formed with a flange (not shown) for tying the rope 91. Furthermore, referring to FIG. 11, an outer edge of a top of the stopper 3 is enlarged to be as a flange 34 so that a rope 91 is tied to a flange.

Second Embodiment:

With reference to FIG. 12, the hammer portion 5 is changed to have a tubular form. A lower section thereof is a metal hammer body 51 and a middle section thereof is a hollow tube 52. A shaft 61 of an umbrella 6 can insert into the hollow tube and then into the buckle. They are fixed by a buckle 62 on the hollow tube 522. The buckle 62 is formed by a sleeve 63 at a top of the hollow tube 52, a brake block 64 in the groove 521 at the top of the hollow tube 52, and a buckle handle 65 fixed at a double ear portion 631 of the sleeve 63 by a pin 66 for pressing the brake block 64. The buckling handle 65 can press the brake block 64 by an eccentric block at a round end thereof so that the brake block 64 enters into a groove 521 to press the umbrella shaft 61 so that it is fixed and can not separate from the hammer portion 5. Above mentioned buckle 62 has been used in the prior art and thus the details will not be described herein.

Third Embodiment

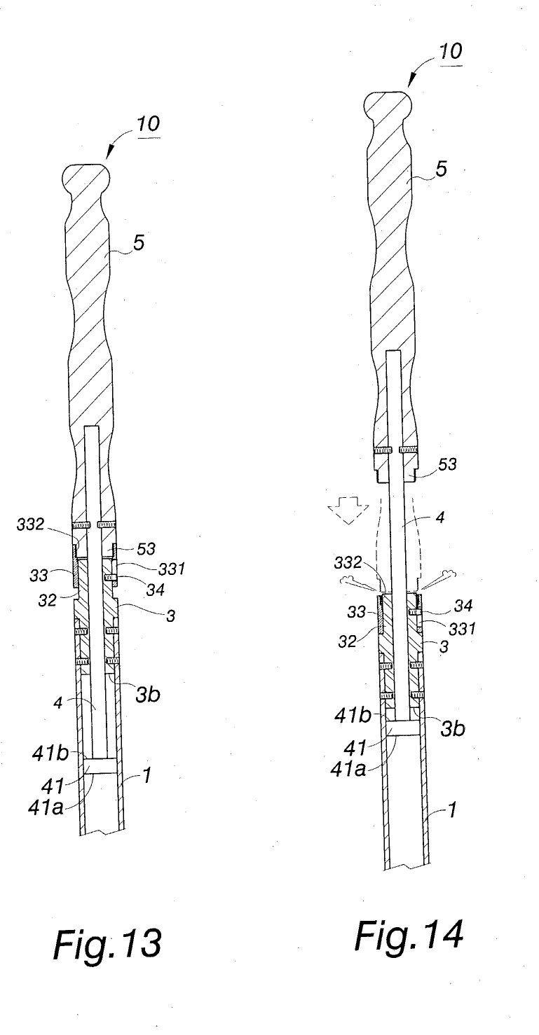

With reference to FIG. 13, a protrusion 32 extends from a top of the stopper 3 of the tube body 1. The protrusion 32 can be engaged with a threaded sleeve 33. The sleeve 33 has a long slot 331. A pin 34 can be inserted into the slot 33 and then the thread sleeve 33 is fixed to the protrusion 32. Thereby, the moving length of the thread sleeve 22 in the protrusion 32 is confined and thus it can not leave from the protrusion. Moreover, a lower end of the hammer portion 5 has outer thread 53. When the thread sleeve 33 is moved upwards, the hammer portion 5 rotates so that the outer thread 53 screws into the thread sleeve 33 to be engaged with the inner thread of the thread sleeve 33. Thereby, the hammer portion 5 is screwed into the thread sleeve 33 firmly. Thus, in packaging and transferring the inserting rod 10, the hammer portion 5 will not move reciprocally. Furthermore, the inserting rod 10 will not be touched so to hurt somebody, especially a child when the inserting rod 10 is not used.

Referring to FIG. 10, an application of the inserting rod 10 in the third embodiment of the present invention is illustrated. When the hammer portion 5 is rotated to leave from the thread sleeve 33, the thread sleeve 33 will fall down by itself. The user may vertically move the hammer portion 5 to knock the protrusion 32 of the stopper 3. Then the tube body 1 and the inserting head 2 will suffer from a force and then they descend. On the contrary, the inner hammer 41 knocks a lower end of the stopper 3 repeatedly, and then the tube body 1 and the inserting head 2 will move upwards.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hammering inserting rod comprising:
a tube body;
an inserting head secured to a bottom of the tube body; a bottom of the inserting rod being a tip end;
a stopper secured to a top of the tube body; and a center of the stopper having a through hole;
a linkage passing through the through hole of the stopper; a lower end of the linkage being installed with an inner hammer;
a hammer portion secured to a top end of the linkage; and
wherein by above components, a user holds the hammer portion to lift and descend the hammer portion repeatedly; the hammer portion will beat the stopper; or the inner hammer is used to beat the stopper so that the tube body and inserting head are inserted into soil or separates from ground.

2. The hammering inserting rod as claimed in claim 1, wherein the inserting rod is integrally formed with the tube body.

3. The hammering inserting rod as claimed in claim 1, wherein a hole at a top of the tube body is used as a through hole for passing through the linkage.

4. The hammering inserting rod as claimed in claim 1, wherein a top of the stopper is an expanding protrusion ring.

5. The hammering inserting rod as claimed in claim 1, wherein an ear is formed at an outer periphery of the tube body for tying a rope.

6. The hammering inserting rod as claimed in claim 1, wherein a lower section of the hammer portion is a metal hammer body and an upper section of the hammer portion is a hollow tube; an upper end of the hollow tube is installed with a buckle.

7. The hammering inserting rod as claimed in claim 1, wherein a protrusion extends from a top of the stopper of the tube body; the protrusion is engaged with a thread sleeve; the thread sleeve has a long slot; a pin is inserted into the slot and then the thread sleeve is fixed to the protrusion firmly.
